(19) United States
(12) Patent Application Publication
(10) Pub. No.: US 2009/0224487 A1
(43) Pub. Date: Sep. 10, 2009

(54) VEHICLE COMPONENT

(75) Inventor: Peter Tyroller, Adelschlag (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 11/573,517

(22) PCT Filed: Jul. 15, 2005
(86) PCT No.: PCT/EP2005/007712

§ 371 Date: Feb. 9, 2007

(30) Foreign Application Priority Data
Aug. 12, 2004 (DE) 10 2004 039 147.5

(51) Int. Cl. F02F 11/00

(52) U.S. Cl. 277/600

(57) ABSTRACT

A vehicle e component is provided having a cavity with at least one opening for containing hydraulic fluid, and a closure sealing the opening, the closure is formed as a domed closure disc (1, 7) which is inserted into the opening (5) and deformed in a radial direction via the application of an axial force.

The invention relates to a vehicle component comprising a cavity with at least one opening for holding hydraulic fluid and comprising closing means that seal the opening.

### BACKGROUND

In vehicle construction, frequently there is the problem that bores must be closed in an oil-tight manner. For a series of hydraulic vehicle components, it is necessary to form bores in order to create channels for the hydraulic fluid. In connection with this condition, these openings must be reliably sealed, which in practice, however, causes considerable expense.

In DE 86 14 676 U1, a screw-in peg is proposed, which has a plastic sealing ring. This solution has the disadvantage, however, that the opening of the vehicle component to be sealed must be provided with an internal thread. In addition, the production of the screw-in peg is relatively complicated and thus expensive.

In DE 101 56 507 A1, a screw plug for the sealing closure of a bore is described. So that this screw plug can be inserted, an internal thread also must be formed in the vehicle component. In addition, automatic assembly is complicated.

Instead of a screw plug, it is also known to use a cover that is pressed into the opening of the bore and that is secured with a securing ring. It has been shown, however, that errors due to the necessarily high pressing forces can be generated in the assembly, which then must be corrected in a way that is time intensive. To achieve an effective seal, the bore and the cover to be pressed in must be manufactured with small tolerances. In addition, it has been determined that during the pressing, in individual cases, shavings can be formed that could, in turn, block the hydraulic channels. Another disadvantage is to be seen in that the cover is a specially manufactured turned part, whereby this solution is associated with relatively high costs.

### SUMMARY

Therefore, the invention is based on the objective of providing a vehicle component with closing means that seal the opening, wherein this component can be produced economically and guarantees a reliable seal.

To meet this objective, according to the invention it is provided that, for a vehicle component of the type named above, the means are embodied as a domed closure disc, which can be inserted into the opening and which can be deformed while expanding in the radial direction due to the application of an axial force.

The vehicle component according to the invention has the advantage that instead of a complicated screw plug or a specially manufactured sealing cover, a relatively easily constructed and therefore economical closure disc is used, which does not have to be pressed but instead is set loosely in the bore, and is then reshaped by an axial force, so that it seals the opening of the bore. In the solution according to the invention, the step of attaching a separate securing device, for example, a securing ring, is eliminated. It is also advantageous that the closure disc does not have to be positioned exactly in the bore.

An especially good seal can be achieved in the vehicle component according to the invention if the cavity or the bore has a shoulder, on which the closure disc can be placed with its edge before pressing, in the area of the opening. Here, the bore can have a certain diameter, which is enlarged in the area of the opening.

The invention provides that the closure disc is either flat or has a flat annular surface at least in the area of its outer periphery after the deformation. During the reshaping, the closure disc expands predominantly in the radial direction, so that it is connected to the vehicle component with a positive and/or non-positive fit. Such a jointed connection maintains its sealing properties even during temperature fluctuations.

It also lies within the scope of the invention that the closure disc and the vehicle component are composed of different materials. If different materials are used, the production of shavings is effectively prevented. In this way, it can be provided, for example, that the closure disc is comprised of steel. In addition, the closure disc can also be provided with surface protection, in order to prevent the occurrence of corrosion.

Especially well suited are closure discs that have been produced according to the DIN 470 standard, because such closure discs have proven especially reliable. In addition, standard closure discs are economical.

It also lies within the scope of the invention that the vehicle component is comprised of a light metal, especially from an aluminum alloy, which is preferably sealed with a closure disc made from steel. The bulging of the closure disc leads to the result that a certain bias remains after the reshaping, so that the material pairing of steel and aluminum is sealed reliably even for temperature fluctuations despite the different coefficients of thermal expansion.

For the vehicle component according to the invention, an entire series of possible applications is conceivable. The vehicle component can be used as a component of an internal combustion engine, for example, it can be used for a chain tensioner. Additional fields of application include, for example, camshaft adjusters or components for a vehicle geartrain or a vehicle steering system. In general, the vehicle component according to the invention can be used anywhere a hydraulic opening has to be sealed.

### BRIEF DESCRIPTION OF DRAWINGS

Additional advantages and details of the invention emerge from the following description of an embodiment and also with reference to the figures. The figures are schematic representations and show:

FIG. 1 is a section view of a vehicle component with a closure disc placed in the opening before reshaping;

FIG. 2 is a view of the vehicle component from FIG. 1 after reshaping; and

FIG. 3 is a view showing an alternate embodiment, in which the closure disc is nearly flat after reshaping.

### DETAILED DESCRIPTION OF THE PREFERRED EMBODIMENTS

The closure disc 1 has a round basic shape provided with bulging. In the illustrated embodiment, a closure disc according to DIN 470 is used, which, for example, has a thickness of 1.6 mm, a diameter of 16 mm, and a radius of curvature of 22 mm. The closure disc 1 is provided with galvanic surface protection, e.g., it can be phosphatized.

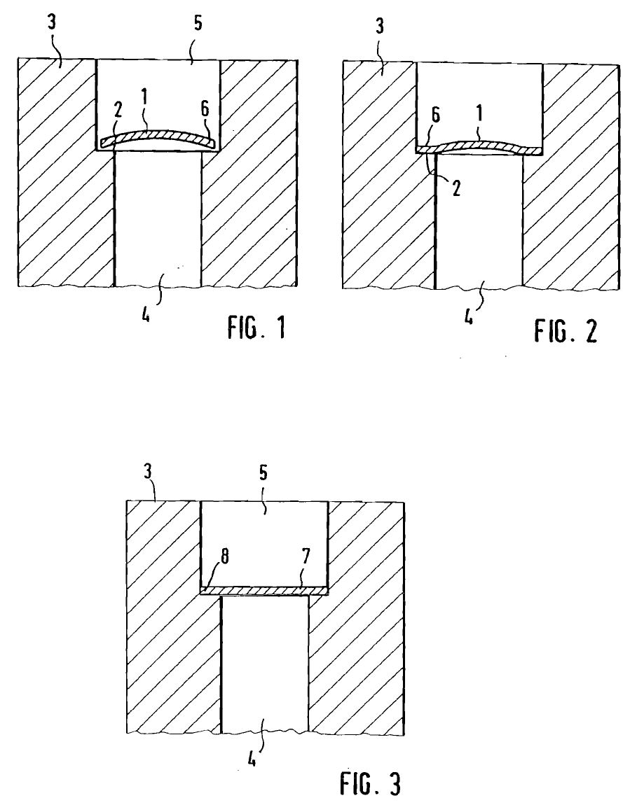

As is to be seen in FIG. 1, during assembly, the closure disc 1 lies on a shoulder 2 of a vehicle component 3. The vehicle component 3 may be a module carrier for a chain tensioner, which has been provided with a bore 4, in order to create internal oil channels for a hydraulic system.

For assembly, the closure disc 1 is set loosely in the opening 5 of the vehicle component with its convex surface pointing outwards as shown in FIG. 1, wherein the inner diameter of the opening 5 is selected so that it is somewhat larger than the outer diameter of the closure disc 1. Because there is small spacing between the closure disc 1 and the inner periphery of the opening 5, the closure disc 1 can be placed without a problem with an automatic assembly robot. It is not necessary to position the closure disc 1 exactly in the opening 5.

For reshaping the closure disc 1, a die is used, whose shape is adapted to the bulging of the closure disc 1. The die acts primarily on the edge 6 of the closure disc 1, wherein the edge 6 is pressed downwards in the radial direction and reshaped by the applied axial force.

Because the vehicle component 3 is made from an aluminum alloy and the closure disc 1 is made from steel, the edge 6 digs into the aluminum material on the entire periphery of the closure disc 1, so that an especially secure connection of these two components is produced.

FIG. 2 shows the vehicle component 3 after reshaping. The edge 6 of the closure disc 1 contacts the shoulder 2 around the entire periphery, so that hydraulic fluid present in the bore 4 cannot escape to the outside from the vehicle component 3. After reshaping, the closure disc 1 has a nearly flat annular surface. Because a certain residual bulging of the closure disc 1 is still present, a permanent bias is present, which also guarantees a secure seal at an elevated temperature.

FIG. 3 shows an alternate embodiment, in which the closure disc is nearly flat after reshaping. The closure disc 7 was reshaped with a higher reshaping force than the closure disc 1 shown in FIGS. 1 and 2. Furthermore, a different reshaping tool was used, so that the nearly flat surface of the closure disc 7 shown in FIG. 3 is produced. This reinforced reshaping has the effect that the edge 8 of the closure disc 7 digs in even farther into the base of the opening 5, so that this connection also produces a reliable seal of the bore 4.

### REFERENCE NUMBERS

1 Closure disc
2 Shoulder
3 Vehicle component
4 Bore
5 Opening
6 Edge
7 Closure disc
8 Edge

1. Vehicle component comprising a cavity with at least one opening for holding hydraulic fluid and a closing element that seals the opening, the closing element comprises a domed closure disc, that is inserted into the opening and deformed so that it is expanded in a radial direction due to application of an axial force.

2. Vehicle component according to claim 1, wherein the cavity is a bore.

3. Vehicle component according to claim 1, wherein the cavity has a shoulder, on which the closure disc is placed with an edge in contact therewith before pressing, in an area of the opening.

4. Vehicle component according to claim 1, wherein the closure disc is flat or has a flat annular surface at least in an area of an outer periphery thereof after reshaping.

5. Vehicle component according to claim 1, wherein the closure disc and the vehicle component are comprised of different materials.

6. Vehicle component according to claim 5, wherein the closure disc is comprised of steel.

7. Vehicle component according to claim 1, wherein the closure disc is provided with surface protection.

8. Vehicle component according to claim 1, wherein the closure disc is in accordance with DIN 470.

9. Vehicle component according to claim 1, wherein the vehicle component is composed of a light-metal alloy.

10. Vehicle component according to claim 1, wherein the vehicle component is a part of an internal combustion engine, a geartrain, or a steering system.

11. Vehicle component of claim 9, wherein the vehicle component comprises an aluminum alloy.
